(19) United States
(12) Patent Application Publication
(10) Pub. No.: US 2014/0073851 A1
(43) Pub. Date: Mar. 13, 2014

(54) MALE ANATOMICAL ENHANCEMENT GARMENT

(71) Applicant: Bruce Gioia, Vancouver (CA)

(72) Inventor: Bruce Gioia, Vancouver (CA)

(21) Appl. No.: 14/078,546

(22) Filed: Nov. 13, 2013

Related U.S. Application Data
(63) Continuation-in-part of application No. 13/180,472, filed on Jul. 11, 2011.

(51) Int. Cl. A61H 1/02

(52) U.S. Cl. CPC A61H 1/02
USPC 600/38

(57) ABSTRACT

A male anatomical enhancement garment is disclosed. The male anatomical enhancement garment may include a base band may that may include snap buttons, hook and loop fasteners or other suitable adjustment mechanism. The garment also includes an embedded bead positioned behind the penis head after the penis is received through the front aperture. The garment includes a scrotal opening for normal movement of the user's testicles in response to temperature variation. The garments sheath's only section may or may not have a silicone bead embedded at both ends as opposed to a single end of the penis sheath. The penis sheath may or may not be used to attach metallic components to induce a mild electrical current to positively stimulate male anatomical functions.

This Continuation-In-Part application of U.S. Non-Provisional application Ser. No. 13/180,472 filed on Jul. 11, 2011. The present application claims priority to U.S. Provisional Application 61/365,342 filed on Jul. 18, 2010, the entire disclosures of both applications of which are incorporated by reference.

### TECHNICAL FIELD & BACKGROUND

Small penis syndrome is a rapidly escalating problem that is having a very destructive psychological impact on contemporary man's sense of masculinity and male identity. This syndrome is primarily related to a relatively normal sized penis that may become smaller than average in a flaccid state. Individuals who experience lack or want for greater genital mass often become deeply embedded in a wide range of psycho-emotional inferiority complexes. These manifest in the most extreme cases with debilitating consequences. There is ample evidence in the medical literature and on on-line accounts where personal anecdotes of men describe a loss of interest not only in relationships with women but also with life itself as a result of their intense dissatisfaction with penis size.

Small penis syndrome is becoming even more of a problem due to the “size matters” stigma that is being aggressively promoted in the media particularly in combination with the easy access now available to online pornography sites which for the most part are exclusively promoting male actors with extra-ordinarily large penises.

This has had an immensely negative impact on the male perception of masculinity and thus his own sense of identity and self-worth. The use of the described anatomical garment may lead to a dramatic increase in self-confidence on a psychological level and a more relaxed style of body language on the physical level as well.

It is an object of the present invention to provide an anatomical enhancement garment that utilizes a completely open scrotal aperture. The open scrotal aperture provides unhindered freedom of movement and comfort to a user's scrotum and testicles by allowing the user's scrotum and testicles to shift position to hang or retract as needed. The reproductive components are thus free to respond to environmental conditions that naturally influence their positioning in relation to a user's body so as to maintain the optimum temperature for sperm production.

It is an object of the present invention to provide an anatomical enhancement garment that reduces feelings of inadequacy associated with small penis complex that also provides support and augmentation and applies a passive genital exercising principle.

### BRIEF DESCRIPTION OF THE DRAWINGS

The present invention will be described by way of exemplary embodiments, but not limitations, illustrated in the accompanying drawing in which like references denote similar elements, and in which:

FIG. 1 illustrates a front environmental perspective view of an anatomical enhancement garment, in accordance with one embodiment of the present invention.

FIG. 2 illustrates a side perspective view of an anatomical enhancement garment, in accordance with one embodiment of the present invention.

FIG. 3 illustrates a side perspective view of a penis sheath and a thick band without a pouch and a telescoping section base band of an anatomical enhancement garment, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

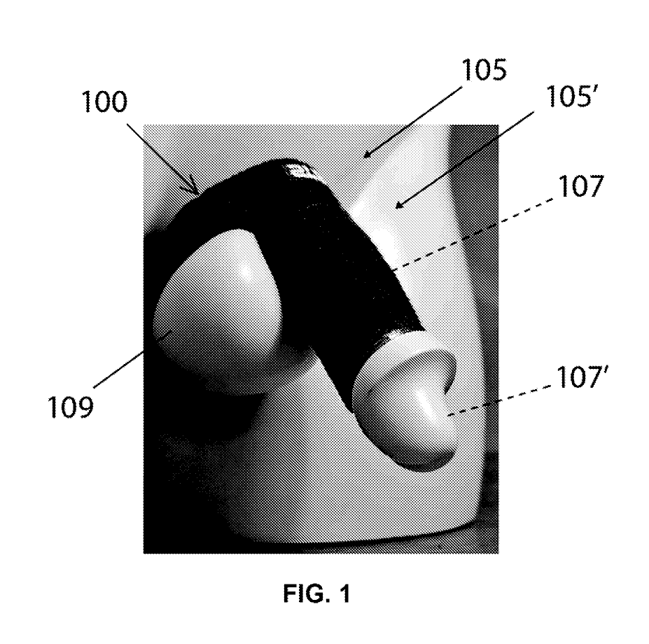

FIG. 1 illustrates a front perspective view of an anatomical enhancement garment 100, in accordance with one embodiment of the present invention.

The anatomical enhancement garment 100 may be worn by a user 105 with a penis 107 or a suitable penal implant (not shown). FIG. 1 illustrates a male user 105′ wearing the anatomical enhancement garment 100 on a male user penis 107. The male user 105′ also has a scrotum 109 and a penis tip 107′ that extends through the anatomical enhancement garment 100.

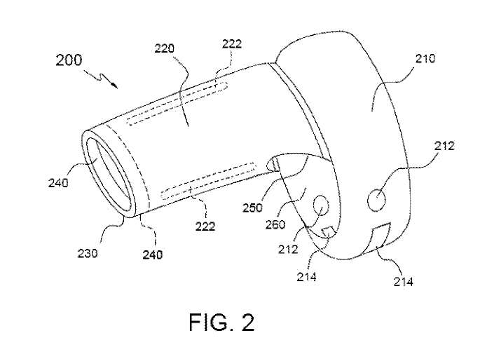

FIG. 2 illustrates a side perspective view of an anatomical enhancement garment 200, in accordance with one embodiment of the present invention.

The anatomical enhancement garment 200 may include a base band 210, a penis sheath 220, a frontal aperture 230, an embedded polymer bead 240, an open scrotal aperture 250 and an interior of the open scrotal aperture 260.

The base band 210 may secure the anatomical enhancement garment 200 to a male user's penis (FIG. 1, 107). The base band 210 may be made of any suitable elastic material to facilitate securing the anatomical enhancement garment 200 to a male user's penis (FIG. 1, 107) which may include snap buttons 212, hook and loop fasteners or VELCRO® fasteners 214 or other suitable adjustment system. The penis sheath 220 may support the shaft of the male user's penis (FIG. 1, 107) to extend the male user's penis (FIG. 1, 107) and prevent it from contracting inward, especially in relatively cold weather. The penis sheath 220 may include attached metallic components 222 utilized to induce a mild electrical current to positively stimulate male anatomical functions. The frontal aperture 230 may allow a user's penis tip (FIG. 1, 107′) to extend through the frontal aperture 230. The frontal aperture 230 may allow for easy donning of the anatomical enhancement garment 200 and provide the convenience of unimpeded urination or erection.

The embedded polymer bead 240 may secure the male user's penis (FIG. 1, 107) from unintentionally retracting back inside the penis sheath 220. The embedded polymer bead 240 may fit on the male user's penis (FIG. 1, 107) to keep the male user's penis (FIG. 1, 107) safely semi-engorged with blood for additional male user's penis size gains. The embedded polymer bead 240 may be made of silicone or other suitable material. The open scrotal aperture 250 may allow a user's scrotum (FIG. 1, 109) to extend through the open scrotal aperture 250 and expose the user's scrotum (FIG. 1, 109) to allow sexual contact with the user's scrotum (FIG. 1, 109) or other suitable purpose. The interior of the open scrotal aperture 260 may support the user's scrotum (FIG. 1, 109) while extended from the open scrotal aperture 250.

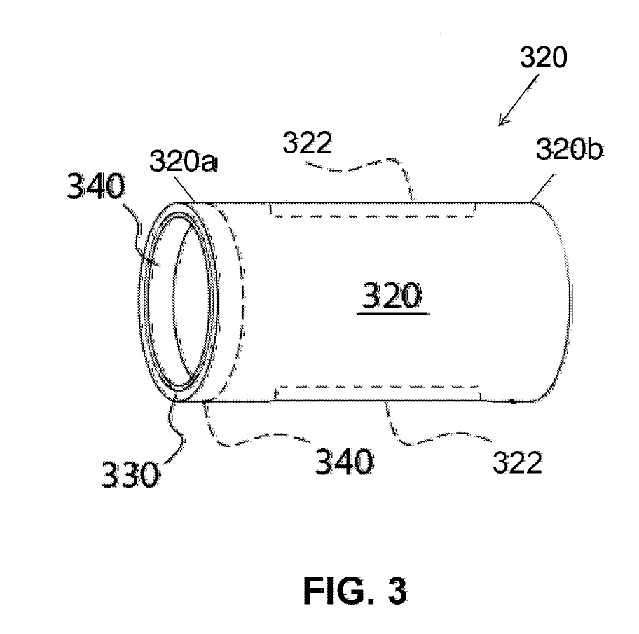

FIG. 3 illustrates a side perspective view of a penis sheath 320 without a thick band (not shown) of an anatomical enhancement garment 100, in accordance with one embodiment of the present invention.

FIG. 3 illustrates a side perspective view of a penis sheath 320 of an anatomical enhancement garment 100, in accordance with one embodiment of the present invention. The penis sheath 320 may include an internal embedded polymer bead 340 disposed on a first end 320a or a second end 320b of the penis sheath 320. The internal embedded polymer bead 340 may be made of silicon or any other suitable rubber like compound. The internal embedded polymer bead 340 may be positioned behind the penis head (FIG. 1, 107′) after the penis (FIG. 1, 107) may be extended through the front opening of the aperture 330 from inside at the first end 320a of the penis sheath 320. The internal embedded polymer bead 340 may be disposed adjacent inside of the frontal aperture 330 and provides added security and non-slip characteristics to the penis (FIG. 1, 107) when the anatomical enhancement garment 100 is worn by the user. Further additional embodiments of the anatomical enhancement garment 100 might include a penis sheath 320 portion of the anatomical enhancement garment 100 without the base band (FIG. 2, 210) components. The anatomical enhancement garment 100 illustrated in FIG. 3 may be utilized as a simple penis extender for continuous extension exercising of the penis tissue with internal embedded polymer beads 340 at both the first end 320a and the second end 320b of the penis sheath 320 if required. The internal embedded polymer bead 340 may be made of a silicone or other suitable material. The penis sheath 320 may include attached metallic components 322 utilized to induce a mild electrical current to positively stimulate male anatomical functions.

The anatomical enhancement garment may be composed of a wide variety of natural and synthetic fiber blends, polymer compounds alone or in combination to provide a full range of thermal, absorption, texture, elastic and odor control properties. The anatomical enhancement garment may be made of high-tech materials that incorporate advanced nano-sized ceramic compounds bonded into the matrix of the fibers. These ceramic compounds are utilized to reflect far infrared rays and/or negative ions back into the body tissue of the male genital organ. The anatomical enhancement garment may promote physical health of tissue male organ with improved blood circulation, more efficient metabolic activity, enhanced sexual function, and quicker healing from injury due to the excessive physical stresses incurred when utilizing aggressive penis exercise routines or other associated injuries.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A male anatomical enhancement garment worn by a user with a penis, a scrotum and a penis tip, comprising:
a base band securing the anatomical enhancement garment to the user's penis;
a snap button or a hook and loop fastener to secure the base band in position;
a penis sheath to support and extend the user's penis to prevent the user's penis from contracting inward;
a penis sheath to attach metallic components utilized to induce a mild electrical current to stimulate male anatomical functions;
a frontal aperture to allow the user's penis tip to extend through the frontal aperture;
an embedded polymer bead to secure the user's penis from unintentionally retracting back inside the penis sheath;
an open scrotal aperture to allow the user's scrotum to extend through the open scrotal aperture and expose the user's scrotum; and
an interior of the open scrotal aperture to support the user's scrotum while extended from the open scrotal aperture.

2. The male anatomical enhancement garment according to claim 1, wherein the penis sheath supports and extends the user's penis to prevent the user's penis from contracting inward in cold weather.

3. The male anatomical enhancement garment according to claim 1, wherein the frontal aperture allows donning of the anatomical enhancement garment.

4. The male anatomical enhancement garment according to claim 1, wherein the frontal aperture allows hassle free convenience during unimpeded urination or erection.

5. The male anatomical enhancement garment according to claim 1, wherein the embedded polymer bead fits on the user's penis to keep the user's penis safely semi-engorged with blood for additional user's penis size gains.

6. The male anatomical enhancement garment according to claim 1, wherein the open scrotal aperture allows sexual contact with the user's scrotum.

7. The male anatomical enhancement garment according to claim 1, wherein the penis tip extends through the anatomical enhancement garment.

8. A male anatomical enhancement garment worn by a user with a penis, a scrotum and a penis tip, comprising:
a base band securing the anatomical enhancement garment to the user's penis;
a snap button or a hook and loop fastener to secure the base band in position;
a penis sheath to support and extend the user's penis to prevent the user's penis from contracting inward, wherein the penis sheath supports and extends the user's penis to prevent the user's penis from contracting inward in cold weather;
a penis sheath to attach metallic bar components utilized to induce a mild electrical current to stimulate male anatomical function;
a frontal aperture to allow the user's penis tip to extend through the frontal aperture;
an embedded polymer bead to secure and extend the user's penis from unintentionally retracting back inside the penis sheath;
an open scrotal aperture to allow the user's scrotum to extend through the open scrotal aperture and expose the user's scrotum; and
an interior of the open scrotal aperture to support the user's scrotum while extended from the open scrotal aperture.

9. The male anatomical enhancement garment according to claim 8, wherein the base band is made of elastic fabric material.

10. The male anatomical enhancement garment according to claim 8, wherein the frontal aperture allows donning of the anatomical enhancement garment.

11. The male anatomical enhancement garment according to claim 8, wherein the frontal aperture allows hassle free convenience of unimpeded urination or erection.

12. The male anatomical enhancement garment according to claim 8, wherein the embedded silicone bead fits on the user's penis to keep the user's penis safely semi-engorged with blood for additional user's penis size gains.

13. The male anatomical enhancement garment according to claim 8, wherein the open scrotal aperture allows sexual contact with the user's scrotum.

14. The male anatomical enhancement garment according to claim 8, wherein the penis tip extends through the anatomical enhancement garment.

15. A male anatomical enhancement garment worn by a user with a penis, a scrotum and a penis tip, comprising:
an elastic fabric base band securing the anatomical enhancement garment to the user's penis;
a snap button or a hook and loop fastener to secure the base band in position;
a penis sheath to support the user's penis to prevent the user's penis from contracting inward, the penis sheath includes a first end and a second end, wherein the penis sheath supports and extends the user's penis to prevent the user's penis from contracting inward in cold weather;
a penis sheath to attach metallic components utilized to induce a mild electrical current to stimulate male anatomical functions;
a frontal aperture to allow the user's penis tip to extend through the frontal aperture and extend through the anatomical enhancement garment;
an embedded polymer bead to secure and extend the user's penis from unintentionally retracting back inside the penis sheath, the embedded type bead disposed on the first end of the penis sheath or the second end of the penis sheath;
an open scrotal aperture to allow the user's scrotum to extend through the open scrotal aperture and expose the user's scrotum; and
an interior of the open scrotal aperture to support the user's scrotum while extended from the open scrotal aperture.

16. The male anatomical enhancement garment according to claim 15, wherein the frontal aperture allows donning of the anatomical enhancement garment.

17. The male anatomical enhancement garment according to claim 15, wherein the frontal aperture allows hassle free convenience during unimpeded urination or erection.

18. The male anatomical enhancement garment according to claim 15, wherein the embedded polymer bead fits on the user's penis to keep the user's penis safely semi-engorged with blood for additional user's penis size gains.

19. The male anatomical enhancement garment according to claim 15, wherein the embedded polymer bead is made of silicon.

20. The male anatomical enhancement garment according to claim 15, wherein the open scrotal aperture allows sexual contact with the user's scrotum.
